(19) United States
(12) Patent Application Publication
(10) Pub. No.: US 2025/0079784 A1
(43) Pub. Date: Mar. 6, 2025

(54) Crimping System

(71) Applicant: Tyco Electronics (Shanghai) Co., Ltd., Shanghai (CN)

(72) Inventors: Qiao Meng, Shanghai (CN); Shen Zhang, Shanghai (CN)

(73) Assignee: Tyco Electronics (Shanghai) Co., Ltd., Shanghai (CN)

(21) Appl. No.: 18/818,849

(22) Filed: Aug. 29, 2024

(30) Foreign Application Priority Data
Aug. 29, 2023 (CN) 202322338462.1

(51) Int. Cl. H01R 43/048

(52) U.S. Cl. CPC H01R 43/048

(57) ABSTRACT

A crimping system includes a base, a fixing device, and a waste recycling device. The base defines a throwing port that allows waste materials to pass through. The fixing device is fixedly installed on the base and adapted to fix a flexible flat piece. The crimping device is movably installed on the base and is movable in two perpendicular, horizontal directions. The crimping device is adapted to crimp a terminal onto the flexible flat piece when it is moved to a predetermined crimping position aligned with the crimping part on the flexible flat piece. The waste recycling device is fixedly installed on the crimping device and moves synchronously with the crimping device. The waste recycling device is adapted to recover waste materials generated during crimping of the terminal, and to eject recovered waste materials through the throwing port when it is moved to a predetermined position aligned with the throwing port.

### CROSS-REFERENCE TO RELATED APPLICATION

This application claims the benefit of Chinese Patent Application No. CN202322338462.1 filed on Aug. 29, 2023, in the State Intellectual Property Office of China, the whole disclosure of which is incorporated herein by reference.

### FIELD OF THE DISCLOSURE

The present disclosure relates to a crimping system, in particular to a crimping system for crimping a terminal onto a flexible flat piece.

### BACKGROUND OF THE INVENTION

In the prior art, a crimping system used to crimp a terminal onto a flexible flat cable, or a flexible circuit board typically includes a base, an X-Y movable platform, a clamping device, and a crimping device. The X-Y movable platform is installed on the base, and the clamping device is installed on the X-Y movable platform to move together with the X-Y movable platform. The clamping device is used to clamp and fix the flexible flat cable or the flexible circuit board. The crimping device is fixedly installed on the base for crimping the terminal onto the flexible flat cable or the flexible circuit board.

In the prior art, during crimping, it is necessary to use the X-Y movable platform to move the flexible flat cable or flexible circuit board on the clamping device to the predetermined crimping position. However, moving the flexible flat cable or flexible circuit board can easily cause it to be pulled and torn, especially when the size of the moved flexible flat cable or flexible circuit board is large, which is more likely to cause damage to the flexible flat cable or flexible circuit board during movement.

### SUMMARY OF THE INVENTION

According to an embodiment of the present disclosure, a crimping system includes a base, a fixing device, and a waste recycling device. The base is formed with a throwing port that allows waste materials to pass through. The fixing device is fixedly installed on the base and adapted to fix a flexible flat piece. The crimping device is movably installed on the base and is movable in two horizontal directions perpendicular to each other. The crimping device is adapted to crimp a terminal onto the flexible flat piece when it is moved to a predetermined crimping position aligned with the crimping part on the flexible flat piece. The waste recycling device is fixedly installed on the crimping device and moves synchronously with the crimping device. The waste recycling device is adapted to recover waste materials generated during crimping of the terminal, and to eject recovered waste materials through the throwing port when it is moved to a predetermined position aligned with the throwing port.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a crimping system according to an exemplary embodiment of the present invention when viewed from one direction;

FIG. 2 shows an illustrative perspective view of a crimping system according to an exemplary embodiment of the present invention when viewed from another direction; and

FIG. 3 shows an illustrative perspective view of a crimping system according to an exemplary embodiment of the present invention, where a fixing device is not shown.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a crimping system is provided. The crimping system includes: a base formed with a throwing port that allows waste materials to pass through; a fixing device which is fixedly installed on the base for fixing a flexible flat piece; a crimping device which is movably installed on the base and can be moved in two horizontal directions perpendicular to each other; and a waste recycling device which is fixedly installed on the crimping device to move synchronously with the crimping device. The crimping device is used to crimp the terminal onto the flexible flat piece, and the waste recycling device is used to recover the waste materials generated during crimping the terminal. The crimping device crimps the terminal onto the flexible flat piece when it is moved to a predetermined crimping position aligned with the crimping part on the flexible flat piece. The waste recycling device throws out or ejects the recovered waste materials through the throwing port when it is moved to a predetermined throwing position aligned with the throwing port.

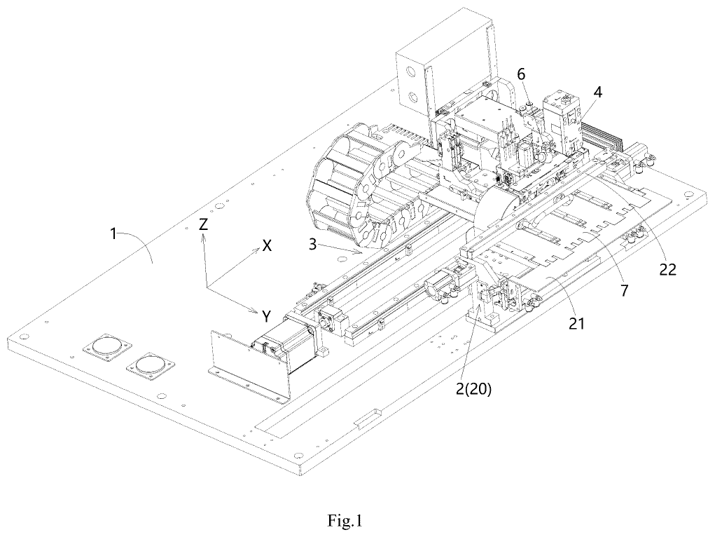

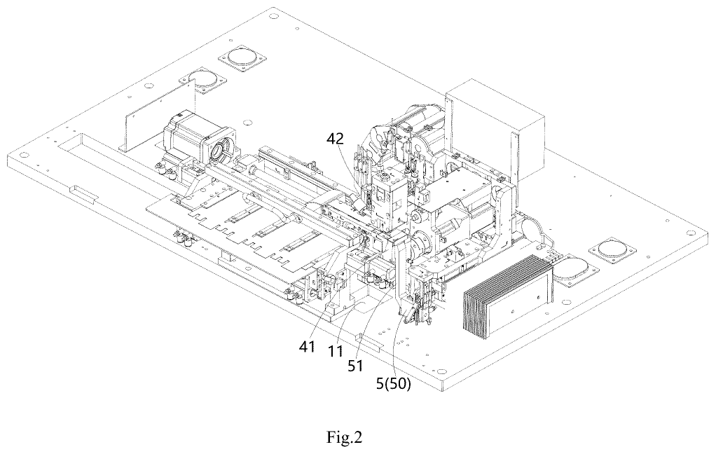

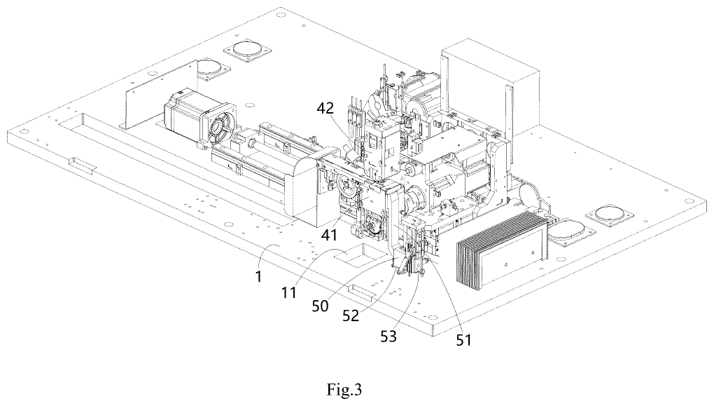

FIG. 1 shows an illustrative perspective view of a crimping system according to an exemplary embodiment of the present invention when viewed from one direction. FIG. 2 shows an illustrative perspective view of a crimping system according to an exemplary embodiment of the present invention when viewed from another direction. FIG. 3 shows an illustrative perspective view of a crimping system according to an exemplary embodiment of the present invention, where the fixing device 2 is not shown.

As shown in FIGS. 1 to 3, in an exemplary embodiment of the present disclosure, a crimping system is disclosed. The crimping system includes: a base 1; a fixing device 2; and a crimping device 4. The fixing device 2 is fixedly installed on the base 1 to fix the flexible flat piece 7. The flexible flat piece 7 can be a flexible flat cable or a flexible circuit board. The crimping device 4 is movably installed on the base 1 and can be moved in two horizontal directions X and Y perpendicular to each other. After being moved to the predetermined crimping position aligned with the crimping part on the flexible flat piece 7, the crimping device 4 presses the terminal onto the flexible flat piece 7.

During crimping, the flexible flat piece 7 is fixed on the fixing device 2 and remains stationary, while the crimping device 4 is moved to the predetermined crimping position to crimp the terminal onto the flexible flat piece. Therefore, during the crimping process, the flexible flat piece 7 is not moved and there is no risk of being pulled or torn.

The crimping system further comprises a movable platform 3. The movable platform 3 is installed on the base 1, which is an X-Y movable platform that can move along a first horizontal direction X and a second horizontal direction Y that are perpendicular to each other. The crimping device 4 is installed on the movable platform 3 to move together with the movable platform 3. The movable platform 3 is used to move the crimping device 4 to the predetermined crimping position. The crimping device 4 cuts off waste materials (for example, a material strip connected to the terminal for conveying the terminal) connected to the terminal while crimping the terminal, and the crimping device 4 has a waste output port for outputting the cut off waste materials.

The crimping device 4 comprises a frame (not shown), a fixed module 41, and a movable module 42. The frame is installed on the movable platform 3. The fixed module 41 is fixed to the frame and the waste output port is formed in the fixed module 41. The movable module 42 is movably installed on the frame and can be moved in a vertical direction Z relative to the fixed module 41. The terminal and flexible flat piece 7 are suitable for being clamped between the fixed module 41 and the movable module 42 to press the terminal onto the flexible flat piece 7.

The crimping device 4 further includes a driving device (not shown, can be a cylinder), which is installed on the frame and connected to the movable module 42 for driving the movable module 42 to move in the vertical direction Z.

The crimping system further includes a visual device 6. The crimping device 4 is suitable for being moved to the predetermined crimping position under the visual guidance of the visual device 6. The visual device 6 is installed on the frame to move synchronously with the crimping device 4. The visual device 6 can be a camera.

In the illustrated embodiments, the crimping system further comprises a waste recovery device 5, which is connected to the waste output port of the crimping device 4 for receiving the waste materials output from the waste output port of the crimping device 4. The waste recycling device 5 is fixedly installed on the crimping device 4 to move synchronously with the crimping device 4.

The waste recycling device 5 includes a recycling box 50 and a recycling channel 51. The recycling channel 51 is connected between the waste output port of the crimping device 4 and the waste inlet of the recycling box 50. The recycling channel 51 is used to transfer the waste materials to the recycling box 50. The waste recycling device 5 further comprises a door 52, which is installed on the waste outlet at the bottom of the recycling box 50 for opening and closing the waste outlet of the recycling box 50.

A throwing port 11 is formed in the base 1. The movable platform 3 is also used to move the recycling box 50 to the predetermined throwing position aligned with the throwing port 11. When a predetermined amount of waste materials is collected in the recycling box 50, the recycling box 50 is moved to the predetermined throwing position and the door 52 is opened to throw out the waste materials through the throwing port 11.

The waste recovery device 5 further includes a driver 53 (such as a cylinder). The driver 53 is installed on the recycling box 50 to drive the door 52 to open and close. The door 52 is rotatably installed on the recycling box 50, and the driver 53 is used to drive the door 52 to rotate between an opened position of opening the waste outlet and a closed position of closing the waste outlet. The waste recycling device 5 further includes wheels installed at the bottom of the recycling box 50, allowing the recycling box 50 to move on the top surface of the base 1 through the wheels. This can provide support for the waste recovery device 5 to avoid it being suspended.

The fixing device 2 comprises a bracket 20, a support platform 21, and a fixture 22. The bracket 20 is fixed to the top surface of the base 1. The support platform 21 is installed on the bracket 20 to support the flexible flat piece 7. The fixture 22 is installed on the support platform 21 to clamp the flexible flat piece 7 onto the top surface of the support platform 21. In the illustrated embodiment, the fixture 22 can be rotated between a clamping position of clamping the flexible flat piece 7 and a releasing position of releasing the flexible flat piece 7.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A crimping system, comprising:
a base defining a throwing port adapted to allow waste materials to pass through;
a fixing device fixedly installed on the base and adapted to fix a flexible flat piece;
a crimping device movably installed on the base and movable in two perpendicular, horizontal directions, the crimping device adapted to crimp a terminal onto the flexible flat piece when moved to a predetermined crimping position aligned with the crimping part on the flexible flat piece; and
a waste recycling device fixedly installed on the crimping device and moving synchronously with the crimping device, the waste recycling device adapted to recover waste materials generated during crimping of the terminal, and to eject recovered waste materials through the throwing port when moved to a predetermined position aligned with the throwing port.

2. The crimping system according to claim 1, further comprising a movable platform installed on the base and movable in a first horizontal direction and a second horizontal direction perpendicular to the first horizontal direction.

3. The crimping system according to claim 2, wherein the crimping device is installed on the movable platform and is adapted to move together with the movable platform.

4. The crimping system according to claim 3, wherein the movable platform is adapted to move the crimping device to the predetermined crimping position and move the waste recycling device to the predetermined position.

5. The crimping system according to claim 4, wherein the crimping device cuts off the waste materials connected to the terminal while crimping the terminal.

6. The crimping system according to claim 5, wherein and the crimping device has a waste output port for outputting the cut off waste materials.

7. The crimping system according to claim 6, wherein the crimping device includes:
a frame installed on the movable platform; and
a fixed module fixed to the frame and the waste output port is formed in the fixed module.

8. The crimping system according to claim 7, wherein the crimping device further includes a movable module movably installed on the frame and movable along a vertical direction relative to the fixed module.

9. The crimping system according to claim 8, wherein the terminal and the flexible flat piece are adapted to be clamped between the fixed module and the movable module to press the terminal onto the flexible flat piece.

10. The crimping system according to claim 9, wherein the crimping device further comprises a driving device installed on the frame and connected to the movable module for driving the movable module to move in the vertical direction.

11. The crimping system according to claim 10, further comprising a visual device installed on the frame to move synchronously with the crimping device, the crimping device adapted to be moved to the predetermined crimping position under the visual guidance of the visual device.

12. The crimping system according to claim 1, wherein the waste recycling device is connected to the waste output port of the crimping device and adapted to receive the waste materials output from the waste output port of the crimping device.

13. The crimping system according to claim 12, wherein the waste recycling device includes:
a recycling box; and
a recycling channel connected between the waste output port of the crimping device and the waste inlet of the recycling box, and adapted to transfer the waste materials to the recycling box.

14. The crimping system according to claim 13, wherein the waste recycling device further includes a door which is installed on the waste outlet at the bottom of the recycling box for opening and closing the waste outlet of the recycling box.

15. The crimping system according to claim 14, wherein, when a predetermined amount of waste materials is collected in the recycling box, the recycling box is moved to the predetermined throwing position and the door is opened to throw out the waste materials through the throwing port.

16. The crimping system according to claim 15, wherein the waste recycling device further includes a driver installed on the recycling box and driving the door to open and close.

17. The crimping system according to claim 16, wherein the door is rotatably installed on the recycling box, and the driver drives the door to rotate between an opened position of opening the waste outlet and a closed position of closing the waste outlet.

18. The crimping system according to claim 13, wherein the waste recycling device further includes wheels installed on a bottom of the recycling box.

19. The crimping system according to claim 1, wherein the fixing device includes:
a bracket fixed to a top surface of the base; and
a support platform installed on the bracket and supporting the flexible flat piece.

20. The crimping system according to claim 19, wherein the fixing device further includes a fixture installed on the support platform and adapted to clamp the flexible flat piece onto the top surface of the support platform.
